(19) United States
(12) Patent Application Publication
(10) Pub. No.: US 2012/0190052 A1
(43) Pub. Date: Jul. 26, 2012

(54) Method of determining factor XIII by means of NAD(P)H-analogues

(75) Inventors: Gerlinde Christ, Marburg (DE); Andreas Kappel, Koenigstein (DE); Frank Vitzhum, Biedenkopf (DE)

(73) Assignee: SIEMENS HEALTHCARE DIAGNOSTICS PRODUCTS GMBH, Marburg (DE)

(21) Appl. No.: 13/498,922

(22) PCT Filed: Jun. 16, 2010
(86) PCT No.: PCT/EP10/03611

§ 371 Date: Mar. 29, 2012

(30) Foreign Application Priority Data
Oct. 5, 2009 (DE) 102009048198.2

(51) Int. Cl. G01N 21/75

(52) U.S. Cl. 435/13; 436/69

(57) ABSTRACT

The invention is in the field of in-vitro diagnostics and relates to a photometric method for determining the blood-clotting factor XIII (factor XIII, F XIII) with the aid of NAD(P)H analogues, and a test kit for carrying out the method. The invention is in the field of in-vitro diagnostics and relates to a photometric method for determining the blood-clotting factor XIII (factor XIII, F XIII) with the aid of NAD(P)H analogues, and a test kit for carrying out the method.

The present invention is in the field of in-vitro diagnostics and relates to a method of determining the blood-clotting factor XIII (factor XIII, F XIII), and a test kit for carrying out the method.

Factor XIII is a blood-clotting factor which acts at the end of the blood coagulation cascade and plays an important role in permanent wound closure. During the last phase of blood coagulation, i.e. fibrin formation, thrombin cleaves fibrinogen. The fibrin monomers formed in this manner aggregate spontaneously to form long fibers and finally a dense branched network of soluble fibrin polymers. Factor XIII, too, is activated by thrombin, resulting in the formation of factor XIIIa. Factor XIIIa causes crosslinking of the fibrin polymers, making the fibrin clot mechanically more stable, less deformable and more resistant to dissolution by plasmin. A congenital or acquired factor XIII deficiency may lead to a tendency to bleed, to wound healing disturbances and to miscarriages. Owing to its clinical relevance, the determination of factor XIII for exclusion or confirmation of a factor XIII deficiency is an important component of coagulation diagnostics.

Factor XIIIa, the activated form of the catalytically inactive proenzyme factor XIII, is a transglutaminase which catalyzes three-dimensional crosslinking of the fibrin polymers by formation of intermolecular amide bonds between lysyl and glutaminyl amino acid side chains of the fibrin molecules. This reaction releases ammonia (NH₃) or ammonium ions (NH₄⁺). This phenomenon is used in various tests to determine factor XIII: Hereinbelow, the term ammonia is used both for ammonia and for ammonium ions.

Muszbek, L. et al. [Clin. Chem. (1985) 31(1), 35-40] describe a method to determine factor XIII in defibrinated plasma samples where the factor XIII of the sample is activated with thrombin to factor XIIIa. Furthermore, the sample is mixed with β-casein and ethylamine which serve as substrates for the formation of intermolecular amide bonds by factor XIIIa. To detect the ammonia released in this reaction quantitatively, the sample is additionally mixed with NADPH (nicotinamide adenine dinucleotide phosphate hydride) and with components of an NADPH-dependent indicator reaction, namely glutamate dehydrogenase (GLDH) and α-ketoglutarate. In the presence of ammonia, GLDH converts α-ketoglutarate into glutamate. This reaction additionally consumes NADPH, and NADP+ (nicotinamide adenine dinucleotide phosphate), the oxidized form of NADPH, is formed. The absorption spectrum of NADP+ is different to that of NADPH, such that the absorption (also referred to as extinction or optical density) of the test mixture changes in proportion to the consumption of NADPH and thus in proportion to the amount of ammonia and thus in proportion to the amount or activity of factor XIII. Alternatively, NADH may be used instead of NADPH in this test mixture. In contrast to NAD(P)+, NAD(P)H has, in addition to an absorption maximum at about 260 nm, an absorption maximum at about 340 nm. The exact position of absorption maxima generally depends on various parameters, in particular on the dielectric constant and the pH of the solution. In general, the absorption maximum of NAD(P)H is in the range from 335 to 345 nm. Accordingly, measuring the change in absorption of the test mixture at a wavelength of 340 nm permits the quantitative determination of factor XIII in a sample.

EP 336 353 A2 or Fickenscher et al. (Thromb Haemost. 1991, 65(5): 535-40) describe a similar method where factor XIII is quantified by the ammonia released. EP 336 353 A2 describes a method for determining factor XIII in fibrin-containing plasma samples without any pretreatment. To suppress the formation of interfering fibrin clots in the reaction mixture, the sample is additionally mixed with a fibrin aggregation inhibitor. The factor XIII in the sample is activated with thrombin in the presence of Ca²⁺ ions to factor XIIIa. Furthermore, the sample is mixed with a synthetic glutamine-containing peptide and glycine ethyl ester which serve as substrates for the formation of intermolecular amide bonds by factor XIIIa. To detect the ammonia released in this reaction quantitatively, the sample is additionally mixed with NADH (nicotinamide adenine dinucleotide hydride) and with components of an NADH-dependent indicator reaction, namely with glutamate dehydrogenase (GLDH) and α-ketoglutarate. In the presence of ammonia, GLDH converts α-ketoglutarate into glutamate. This reaction additionally consumes NADH, and NAD+, the oxidized form of NADH, is formed. The absorption spectrum of NAD+ is different to that of NADH, such that the absorption of the test mixture changes in proportion to the consumption of NADH and thus in proportion to the amount of ammonia and thus in proportion to the amount or activity of factor XIII. Alternatively, NADPH may be used instead of NADH in this test mixture. By measuring the change in absorption of the test mixture at a wavelength of 340 nm, quantitative determination of factor XIII in a sample is possible. A commercial test based on the test principle described in EP 336 353 A2 is the Berichrom® F XIII test from Siemens Healthcare Diagnostics.

The processes described have the disadvantage that they are relatively susceptible to sample-intrinsic interfering substances. In individual cases, samples from patients may contain abnormally high concentrations of one or more intrinsic substances, i.e. substances produced in the body, which, once a tolerable concentration has been exceeded, are found to interfere in photometrical detection methods, which may result in a systematic error. Hemolytic, icteric and/or lipemic serum or plasma samples, so-called HIL samples, which have abnormally high hemoglobin, bilirubin and/or triglyceride concentrations, are known to cause problems. Abnormally high concentrations of these interfering substances may be caused by a pathological state of the patient or else by an improper sample preparation or storage.

Accordingly, it was an object of the present invention to provide a method for determining factor XIII which is lees susceptible to sample-intrinsic interfering substances. The object was in particular to provide a method which allows the determination of factor XIII in samples having high concentrations of hemoglobin, bilirubin and/or triglyceride.

The object is achieved by modifying a known method for determining factor XIII where
a) the sample is mixed with I. a substance for activating the factor XIII to factor XIIIa (for example with thrombin in the presence of Ca²⁺ ions), II. with an acceptor substrate for factor XIIIa (for example with a glutamine-containing peptide), III. with an amino group donor substrate for factor XIIIa (for example with a primary amine), IV. with NADH or NADPH and V. with an agent capable of oxidizing NADH to NAD+ in the presence of ammonia (for example consisting of glutamate dehydrogenase and α-ketoglutarate) and
b) the change in absorption of the test mixture is measured,
   such that instead of NADH or NADPH an analog of NADH or NADPH, a so-called NAD(P)H analog, having an absorption maximum above 350 nm is used.

For the sake of simplicity, the term NAD(P)H is used when embodiments relate both to the phosphorylated and the non-phosphorylated form of NADH, i.e. when both NADH and NADPH are intended. The term NAD(P)+ is used when embodiments relate both to the phosphorylated and the non-phosphorylated form of NADH in the oxidized state, i.e. when both NAD+ and NADP+ are intended.

For the purposes of the present invention, the term “NAD(P)H analog” is to be understood as meaning a substance which, like NAD(P)H, can act as a cosubstrate for an NAD(P)H-dependent dehydrogenase which converts ammonia. According to the invention, this has to be an analog where the oxidized and the reduced form have different absorption maxima, where the absorption maximum of the reduced form of the NAD(P)H analog is above 350 nm.

The NAD(P)H analogues are preferably organic cyclic and heterocyclic compounds which allow a redox reaction based on the concept of the transfer of a hydride ion, i.e. a redox reaction in which the equivalent of a proton and two electrons is transferred.

This includes in particular organic compounds, preferably heterocyclic compounds, which can be converted on reduction, i.e. the uptake of a hydride ion, from a quinoid form into a benzoid form and vice versa. Preference is given in particular to pyridine derivatives. From among these, structural analogues of nicotinamide are preferred.

Particular preference is given to NAD(P)H structural analogues in which the nicotinamide group of the NAD(P)H has been replaced by another group. Preference is given here to organic cyclic and heterocyclic compounds allowing a redox reaction based on the concept of the transfer of a hydride ion, i.e. a redox reaction in which the equivalent of a proton and two electrons is transferred. This includes in particular organic compounds, preferably heterocyclic compounds, which can be converted on reduction, i.e. the uptake of a hydride ion, from a quinoid form into a benzoid form and vice versa. Preference is given in particular to pyridine derivatives.

Excluded from the pyridine derivatives for use in the method according to the invention are analogues having a substituent in position 4 of the pyridine ring, for example 4-methylnicotinamide adenine dinucleotide. Such analogues can be reduced chemically, for example with dithionite (M. Jarman and F. Searle: Potential coenzyme inhibitors V—The synthesis and some properties of 4-methylnicotinamide adenine dinucleotide, Biochemical Pharmacology, Vol. 21, 455-464, 1972); however, for sterical reasons they have limited utility for an enzyme-catalyzed transfer of hydride ions.

Particular preference is given to NAD(P)H structural analogues having a side-chain in position 3 of the pyridine group. Suitable substituents are, preferably, carbonyl compounds, for example an aldehyde, acetyl, carboxylic acid, thioaldehyde, thioacetyl, thiocarboxylic acid, thiocarboxamide, selenoaldehyde, selenoacetyl, selenocarboxylic acid, selenocarboxamide group, etc.

Special preference is given here to NAD(P)H structural analogues having the pyridine analogues 3-acetylpyridine, 3-(carb)-aldehydepyridines, thionicotinamide and selenonicotinamide. From among this group, in turn, particular preference is given to thionicotinamide.

The absorption maximum of seleno-NAD(P)H, thio-NAD(P)H, 3-acetylpyridine adenosine dinucleotide hydride and 3-aldehydepyridine adenosine dinucleotide hydride are located such that the reaction can be monitored, for example, at about 417 nm, 400 nm, 365 nm and 358 nm, respectively (Werner Hensel, Dagmar Rakow, Wolfram Christ: Convenient method for preparation and purification of nicotinamide mononucleotide analogues. Analytical Biochemistry, 68, 128-137, 1975; Christ, W. and Coper H.: Properties of selenonicotinamide adenine dinucleotide phosphate, an analogue of NADP. FEBS Letters, Vol. 2, Number 4, 267-269).

NAD(P)H analogues may have other enzyme-kinetic properties than NAD(P)H. For example, the conversion of analogues may be worse. This may be compensated for at least partially by adjusting the concentration of the analog, the enzyme or other components in the reaction mixture, such that the reaction still proceeds to a sufficient extent. An analog which is not converted by a corresponding enzyme or even acts as an inhibitor is not according to the invention. For example, it has to be assumed that pyridine analogues having a substituent in position 4, for example 4-methylnicotinamide adenine dinucleotide, are not suitable (see above).

The search for or the discovery of NAD(P)H analogues can be carried out with the aid of enzyme reactions catalyzed by NAD(P)H-dependent dehydrogenases. In a corresponding screening method, it is possible to use, for example the systems that are also used in an F XIII test. To identify NAD(P)H analogues suitable for use in the process according to the invention, their spectral properties are preferably determined first. Preference is given to determining the spectral properties of the reduced form. An analog has to have an absorption maximum above 350 nm. The analog in question is added to a test solution and the change of the absorption in the relevant wavelength range is monotored. Here, it is preferred to employ different concentrations of the analog. To this end, for example, 20 μl of a solution of the reduced form of an analog having different concentrations may be pipetted into 2880 μl of a test solution of pH 7.9 which contains 84.7 mM imidazole buffer, 13.6 mM 2-oxoglutarate, 217 mM ammonium acetate, 0.9 mM ethylenediaminetetraacetate and 1.7 mM adenosine-5′-diphosphate. If the reduced analog is converted, i.e. oxidized, the absorption, which can be monitored photometrically, decreases. In this manner, it is possible to determine NAD(P)H analogues according to the invention.

Appropriate NAD(P)H analogues may be synthesized via the pyridine analogues which are initially synthesized chemically, alkylated to the mononucleotide analogues, likewise by chemical methods, and then condensed, for example enzymatically with the aid of an NAD pyrophosphorylase or chemically with adenosine triphosphate (ATP) or adenosine diphosphate (ADP), to give the corresponding NAD(P)+ or NAD(P)H analog. In this manner, the oxidized form, i.e. the NAD(P)+ analog, is usually synthesized first. The reduction of the diphosphopyridine nucleotide or the NAD(P)+ analog can be carried out, for example, with dithionite (Werner Hensel, Dagmar Rakow, Wolfram Christ: Convenient method for preparation and purification of nicotinamide mononucleotide analogues, Analytical Biochemistry, 68, 128-137, 1975; M. Jarman and F. Searle: Potential coenzyme inhibitors V—The synthesis and some properties of 4-methylnicotinamide adenine dinucleotide, Biochemical Pharmacology, Vol. 21, 455-464, 1972).

Since thio-NAD(P)H has an absorption maximum which, compared to other analogues, is very particularly in the long-wave range, is additionally efficiently converted enzymatically by most dehydrogenases, is comparatively stable and commercially available, this NAD(P)H analog is very particularly preferred. A further preferred NAD(P)H analog is seleno-NAD(P)H.

Thio-NADH (thionicotinamide adenine dinucleotide hydride) or thio-NADPH (thionicotinamide adenine dinucleotide phosphate hydride) can be oxidized in a manner analogous to NADH and NADPH, namely to thio-NAD+ and thio-NADP+, respectively, and have, as is known, other optical properties than NADH and NADPH, respectively, so that a change in absorption owing to the oxidation to thio-NAD+ and thio-NADP+, respectively, can be measured at wavelengths of about 340 nm to about 430 nm.

Accordingly, the present invention provides the use of an NAD(P)H analog having an absorption maximum above 350 nm in a method for determining factor XIII in a sample.

The present invention furthermore provides the use of thio-NADH or of thio-NADPH (i.e. Thio-NAD(P)H) in a method for determining factor XIII in a sample.

The present invention furthermore provides the use of seleno-NADH or of seleno-NADPH (i.e. seleno-NAD(P)H) in a method for determining factor XIII in a sample.

The present invention furthermore relates to a method for determining factor XIII in a sample where
a) the sample is mixed with one or more reagents comprising
   I. a substance or a substance mixture for activating the factor XIII to factor XIIIa,
   II. an acceptor substrate for factor XIIIa having at least one glutaminyl group,
   III. an amino group donor substrate for factor XIIIa,
   IV. an NAD(P)H analog having an absorption maximum above 350 nm, and
   V. an agent which is capable of oxidizing NAD(P)H to NAD(P)+ or an NAD(P)H analog to the corresponding NAD(P)+ analog in the presence of ammonia,
and
b) the change in absorption of the test mixture is measured.

In a preferred embodiment of the method according to the invention, the NAD(P)H analog used is thio-NAD(P)H.

In a further preferred embodiment of the method according to the invention, the NAD(P)H analog used is seleno-NAD(P)H.

A substance suitable for activating factor XIII to factor XIIIa is in particular thrombin, for example of human or bovine origin or else recombinant thrombin. Likewise suitable are substances or substance mixtures such as, for example, factor Xa, the snake venom ecarin or a mixture of tissue factor, phospholipids and Ca²⁺ ions which effect indirect activation of factor XIII by directly or indirectly activating the prothrombin present in the sample to thrombin which in turn activates factor XIII.

The term “acceptor substrate for factor XIIIa having at least one glutaminyl group” is to be understood as meaning a polypeptide or peptide mimetic having at least one glutaminyl group, for example from the amino acid glutamine. Known acceptor substrates for factor XIIIa are, for example, β-casein and a large number of synthetic peptides. Suitable synthetic peptides are described, for example, in EP 314 023 A2.

The term “amino group donor substrate for factor XIIIa” is to be understood as meaning in particular primary amines. Preferred primary amines are ethanolamine, putrescine, cadaverine, diaminoethane, aminoethane. Particuarly preferred primary amines are glycine ethyl ester or glycine methyl ester.

An “agent capable of oxidizing NADH to NAD+ in the presence of ammonia” is preferably an enzyme/substrate system which comprises an enzyme and a substrate for the enzyme, where the enzyme acts catalytically on the substrate and thereby oxidizes NADH to NAD+ or NADPH to NADP+ (i.e. NAD(P)H to NAD(P)+) and thus also thio-NADH to thio-NAD+ or thio-NADPH to thio-NADP+ or other NAD(P)H analogues according to the invention in the presence of ammonia.

Suitable enzyme/substrate systems are dehydrogenases and substrates thereof, which convert NAD(P)H or NAD(P)H analogues as cofactor together wuth ammonia. These are in particular amino acid dehydrogenases such as D-amino acid dehydrogenases and L-amino acid dehydrogenases. Examples of these are alanine dehydrogenase, glutamate dehydrogenase, serine-2 dehydrogenase, valine dehydrogenase, leucine dehydrogenase, glycine dehydro-genase, lysine dehydrogenase, tryptophane dehydrogenase, phenylalanine dehydrogenase, asparate dehydrogenase, diamino-pimelate dehydrogenase, N-methylalanine dehydrogenase, L-erythro-3, 5-diaminohexanoate dehydrogenase and 2,4-diaminopentanoate dehydrogenase. The respective substrates for above-described direction of reaction of the amination are ammonia and the respective oxo compounds. According to the order of the above examples, these are the 2-oxo acids for the amino acid dehydrogenases and also pyruvate, alpha-ketoglutarate (2-oxoglutarate), 3-hydroxypyruvate, 3-methyl-2-oxobutanoate, 4-methyl-2-oxopentanoate, glyoxylate, 1,2-didehydropiperidine-2-carboxylate, indol-3-ylpyruvate, phenylpyruvate, oxaloacetate, L-2-amino-6-oxoheptanedioate, pyruvate and methylamine, (S)-5-amino-3-oxohexanoate, and L-2-amino-6-oxoheptanedioate. Suitable enzyme/substrate systems are also, for example, the glutamate dehydrogenase/ketoglutarate system or the alanine dehydrogenase/pyruvate system or the serine 2-dehydrogenase/3-hydroxypyruvate system or the valine dehydrogenase/3-methyl-2-oxobutanoate system or the leucine dehydrogenase/4-methyl-2-oxopentanoate system or the glycine dehydrogenase/glyoxylate system or the lysine dehydrogenase/1,2-didehydropiperidine-2-carboxylate system or the phenylalanine/phenylpyruvate system or the aspartate dehydrogenase/oxaloacetate system or the glucose-6-phosphate dehydrogenase/D-glucono-1,5-lactone-6-phosphate system.

In a preferred embodiment of the method according to the invention, the sample, preferably a plasma sample, is additionally mixed with a fibrin aggregation inhibitor. Fibrin aggregation inhibitors are substances which prevent the aggregation of thrombin-induced fibrin monomers. In this manner, the formation of a fibrin clot in a fibrinogen-containing sample, which would otherwise negatively affect the measurement of the absorption of the test mixture, is prevented. Preferred fibrin aggregation inhibitors are synthetic peptides such as, for example, a peptide of the sequence Gly-Pro-Arg-Pro (commercially available as Pefabloc®FG, Pentapharm, Switzerland). Other preferred peptides which can be used as fibrin aggregation inhibitors, in particular the preferred peptide of the sequence Gly-Pro-Arg-Pro-Ala, are described in EP 456 152 A2.

In a further embodiment, the sample is additionally mixed with a heparin-neutralizing substance, for example with hexadimethrine bromide (also known as Polybrene®) to eliminate the thrombin-inhibiting action of heparin which may be present, for example, in samples from patients undergoing heparin therapy.

Components I to V which are mixed with the sample to give a test mixture can each be mixed separately, i.e. in the form of individual reagents and in succession, with the sample; however, they can also be combined in a single reagent which is mixed with the sample in a single pipetting step. The reagent or the reagents preferably comprise a buffer matrix in which the substances are dissolved. A suitable buffer matrix contains, for example, HEPES, bicine, NaCl, albumin and/or preservatives such as, for example, sodium azide, and it has preferably a pH of from 6.0 to 9.0, particularly preferably from 6.5 to 8.5. Since calcium ions are required for the activation of F XIII, the buffer matrix furthermore comprises a calcium salt, preferably calcium chloride. Mixing of the reagent or the reagents with the sample may be carried out manually or using automatic instruments for measuring coagulation.

The amount of the NAD(P)H analog added to the test mixture has to be optimized depending on which agent capable of oxidizing the NAD(P)H analog to the corresponding NADP+ analog in the presence of ammonia is used. If the glutamate dehydrogenase/ketoglutarate system is used, the amount chosen for thio-NADH, for example, is preferably such that the final concentration of the thio-NADH in the test mixture is 10-500 μM, preferably 50-400 μM.

If the glutamate dehydrogenase/ketoglutarate system is used in the method according to the invention as the agent capable of oxidizing NADH to NAD in the presence of ammonia, the amount of glutamate dehydrogenase added to the test mixture is chosen such that the final concentration in the test mixture is 2-500 IU/ml, preferably 5-250 IU/ml.

A suitable sample material is in particular fibrinogen-containing plasma. However, according to the method according to the invention it is also possible to determine factor XIII in defibrinated plasma.

The change in absorption (ΔE) of the test mixture is measured with the aid of a photometer comprising a light source, which sends a beam of light through the test mixture to be measured, and a detector, which measures the intensity of the light which has passed through and converts it into an electrical signal. The change in absorption is measured using light of a wavelength of about 340 nm to about 430 nm, preferably light of a wavelength of about 380 to about 420 nm, very particularly preferably light of a wavelength of about 390 to about 410 nm. The changing absorption as a function of time correlates with the factor XIII activity. The decrease in absorption (E) of the test mixture owing to the consumption of thio-NADH or thio-NADPH is, in particular in the linear range of the reaction kinetics, directly proportional to the factor XIII activity. The factor XIII activity of a sample is preferably calculated by comparison with a sample of pooled normal plasma which per definitionem has a factor XIII activity of 100%.

The present invention furthermore provides a test kit for carrying out the method according to the invention for determining factor XIII in a sample, where the test kit comprises the following components:
1. a first reagent comprising a substance or a substance mixture for activating factor XIII to factor XIIIa, preferably thrombin;
2. a second reagent comprising
   at least one acceptor substrate having at least one glutaminyl group for factor XIIIa, preferably a synthetic peptide having at least one glutaminyl radical as amine acceptor,
   at least one amino group donor substrate for factor XIIIa, preferably a primary amine, and
   at least one agent capable of oxidizing, in the presence of ammonia, NAD(P)H to NAD(P)+ or an NAD(P)H analog to the corresponding NAD(P)+ analog, the agent preferably consisting of glutamate
   dehydrogenase and ketoglutarate; and
3. a third reagent comprising at least one NAD(P)H analog having an absorption maximum above 350 nm.

In a preferred test kit, the reagent comprising the NAD(P)H analog comprises thio-NAD(P)H or seleno-NAD(P)H.

The reagents may additionally comprise preservatives, salts, buffer substances and/or stabilizers, for example sodium azide and albumin. The reagents can be provided either as liquid reagents or as lyophilizates. If some or all of the reagents of the test kit are present as lyophilizates, the test kit may additionally comprise the solvents required for dissolving the lyophilizates, for example distilled water and/or suitable buffers.

In a preferred test kit, the first reagent, which comprises thrombin for activating factor XIII to factor XIIIa, additionally comprises calcium chloride and/or a fibrin aggregation inhibitor and/or hexadimethrine bromide.

### BRIEF DESCRIPTION OF THE FIGURES

FIG. 1 Factor XIII determination with thio-NADH. The decrease in absorption of the test mixture is proportional to the factor XIII concentration in the sample (see Example 1).

FIG. 2 Factor XIII determination in hemoglobin-spiked plasma samples (see Example 2). The upper diagram shows the results of the NADH F XIII test. The lower diagram shows the results of the thio-NADH F XIII test according to the invention. The hatched horizontal lines mark 10% deviation from the starting value at 0 mg/ml hemoglobin. The thio-NADH F XIII test exceeds the 10% threshold only at considerably higher hemoglobin concentrations than the NADH F XIII test of the prior art.

FIG. 3 Factor XIII determination in cholesterol-spiked plasma samples (see Example 2). The upper diagram shows the results of the NADH F XIII test. The lower diagram shows the results of the thio-NADH F XIII test according to the invention. The hatched horizontal lines mark 10% deviation from the starting value at 0 mg/ml cholesterol. In contrast to the NADH F XIII test of the prior art, the thio-NADH F XIII test according to the invention does not exceed the 10% threshold at the cholesterol concentrations tested.

FIG. 4 Factor XIII determination in bilirubin-spiked plasma samples (see Example 2). The upper diagram shows the results of the NADH F XIII test. The lower diagram shows the results of the thio-NADH F XIII test according to the invention. The hatched horizontal lines mark 10% deviation from the starting value at 0 mg/ml bilirubin. In contrast to the NADH F XIII test of the prior art, the thio-NADH F XIII test according to the invention does not exceed the 10% threshold at the bilirubin concentrations tested.

### EXAMPLES

### Example 1

Determination According to the Invention of Factor XIII Using Thio-NADH

The following reagents were prepared:

### Activator Reagent (pH 8.3):

292 μM thio-NADH (Oriental Yeast Company, Rotterdam, The Netherlands)
bovine thrombin (10 IU/ml)
Gly-Pro-Arg-Pro-Ala-amide as fibrin aggregation inhibitor (2 g/l)
calcium chloride (1.2 g/l)
hexadimethrine bromide (10 mg/l)
bovine albumin
bicine buffer (100 mmol/l)
   Detection reagent (pH 6.5):
glutamate dehydrogenase 260 IU/ml)
Leu-Gly-Pro-Gly-Gln-Ser-Lys-Val-lle-Gly-amide as F XIII acceptor substrate (2.4 g/l)
ADP
glycine ethyl ester (1.4 g/l)
α-ketoglutarate (2.7 g/l)
bovine albumin
HEPES buffer (10 mmol/l)

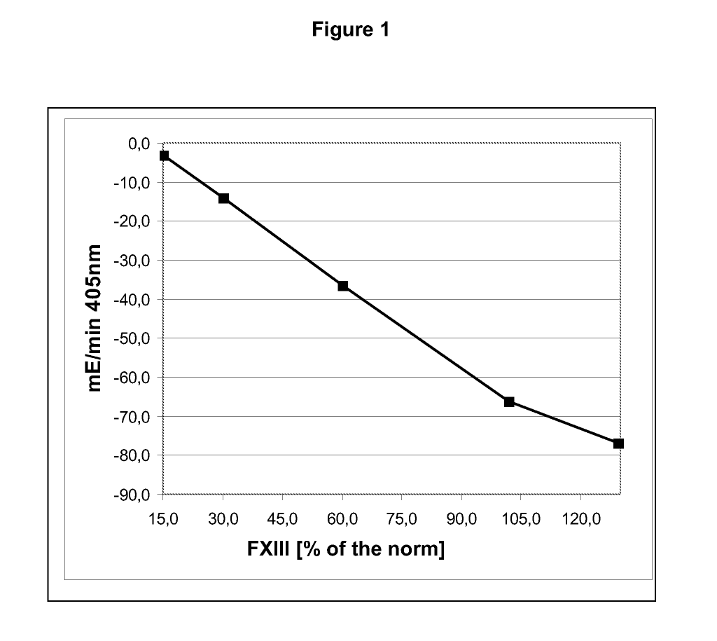

For the test, 75 μl of activator reagent, 75 μl of detection reagent and 15 μl of a sample were combined in a cuvette on the BCS®-XP coagulation analyzer (Siemens Healthcare Diagnostics Products GmbH, Marburg, Germany) and incubated at 37 C. After 5 minutes, the measurement of the absorption at a wavelength of 405 nm was started. For evaluation, the change of the absorption per minute at 405 nm was calculated for a time window of 60 seconds-350 seconds after the start of the measurement. For calibration, human standard plasma (Siemens Healthcare Diagnostics Products GmbH, Marburg, Germany) with a factor XIII concentration of 102% of the norm was used as standard. Calibration points having a lower factor XIII concentration were obtained by diluting the standard with 0.9% NaCl solution, calibration points having a higher factor XIII concentration were obtained by using an increased volume of standard in the test. FIG. 1 shows a typical calibration curve.

### Example 2

Determination According to the Invention of Factor XIII Using Thio-NADH in HIL-Samples

Standard human plasma (SHP, Siemens Healthcare Diagnostics) was mixed with increasing concentrations of hemoglobin, bilirubin, triglycerides or cholesterol, which were in each case metered into the plasma at a constant volume. To this end, 60 μl of a solution of various concentrations of the substance in question were added to 540 μl of SHP. For this purpose, hemoglobin was dissolved in tris-buffered saline (TBS: 150 mM NaCl, 50 mM tris, pH 7.6), cholesterol was dissolved in TBS comprising 40 mg/ml of human serum albumin, and bilirubin was dissolved in 0.05 M NaOH, and metered into the SHP. To determine the starting value, 60 μl of the respective buffer solution without any added substance were added to 540 μl of SHP. The factor XIII activity of the plasma samples spiked in this manner were then determined in triplicate by the method according to the invention using thio-NADH (see Example 1). For comparison, the same samples were determined in triplicate according to the instructions of the manufacturer by the Berichrom® FXIII test (Siemens Healthcare Diagnostics Products GmbH, Marburg, Germany), which uses NADH. If the measured results for the spiked samples deviate from the measured results for the unspiked sample by more than 10%, there is an interference, i.e. a reliable determination of factor XIII is not possible.

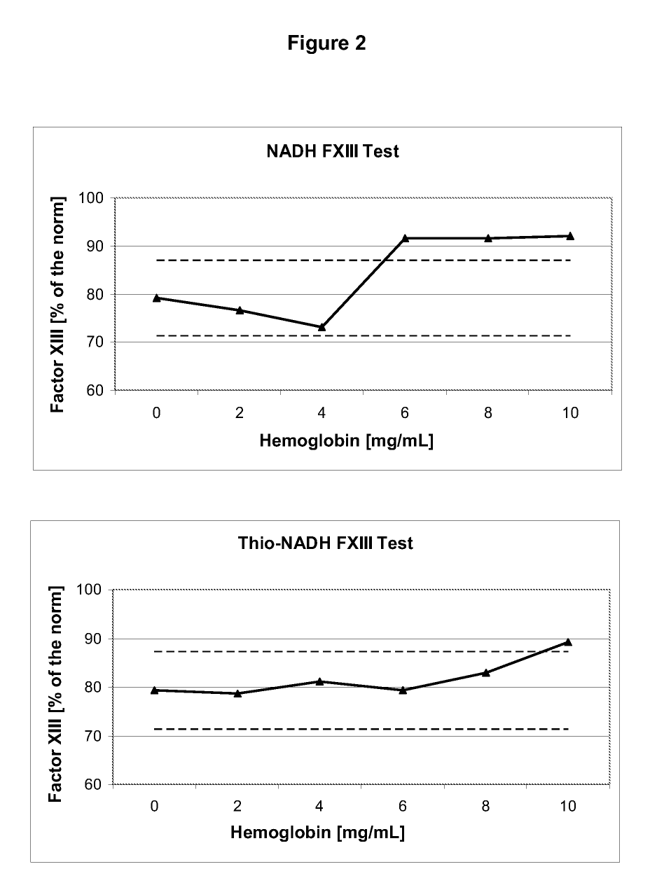

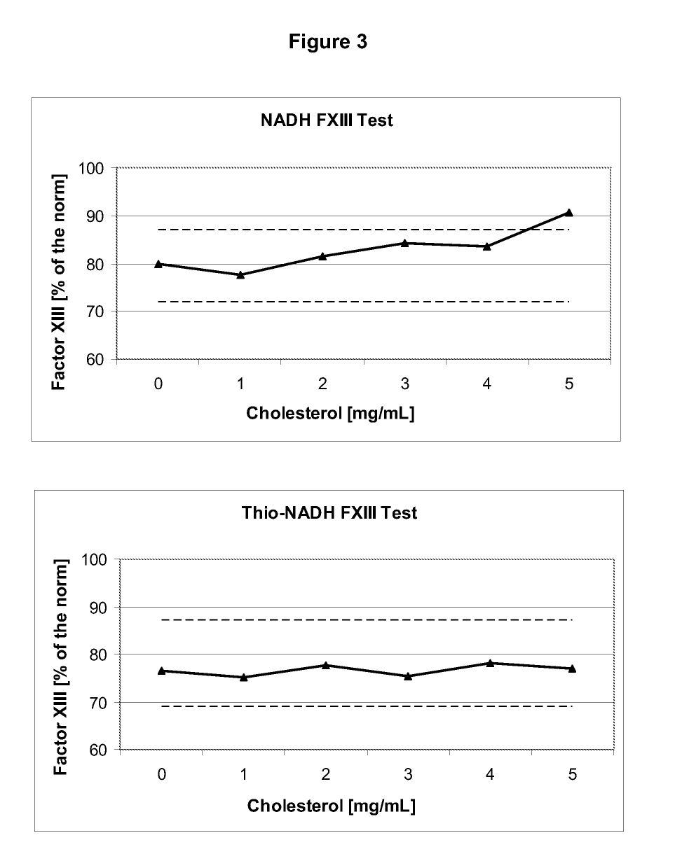

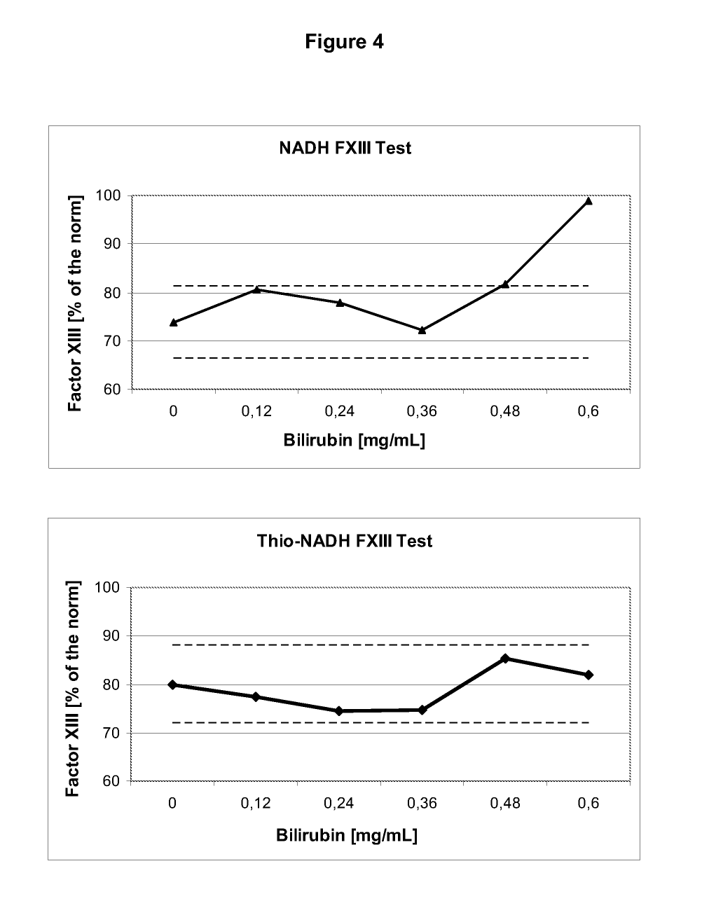

The results for the hemoglobin-, cholesterol- and bilirubin-spiked samples are shown in FIGS. 2 to 4.

Table 1 states the concentrations of interfering substances at which no interference with the Berichrom® FXIII test (short: NADH F XIII test) or with the method according to the invention (short: thio-NADH F XIII test) is observed. The comparison of the two tests shows that the test according to the invention tolerates higher concentrations of interfering substances, i.e. is less susceptible to interference by sample-intrinsic interfering substances. With the interfering substances cholesterol and bilirubin, the thio-NADH test according to the invention tolerates even the highest amount metered in, so that interference presumably occurs only at higher concentrations than the concentrations stated in Table 1.

TABLE 1

| | No interference up to: | | |
|---|---|---|---|
| F XIII test | hemoglobin | cholesterol | bilirubin |
| NADH | 4 mg/ml | 4 mg/ml | 0.36 mg/ml |
| Thio-NADH | 8 mg/ml | 5 mg/ml | 0.6 mg/ml |

1. A method for determining factor XIII in a sample where
a) the sample is mixed with one or more reagents comprising
I. a substance or a substance mixture for activating the factor XIII to factor XIIIa,
II. an acceptor substrate for factor XIIIa having at least one glutaminyl group,
III. an amino group donor substrate for factor XIIIa,
IV. an NAD(P)H analog having an absorption maximum above 350 nm, and
V. an agent which is capable of oxidizing NAD(P)H to NAD(P)+ or an NAD(P)H analog to the corresponding NAD(P)+ analog in the presence of ammonia, and
b) the change in absorption of the test mixture is measured.

2. The method as claimed in claim 1, where the NAD(P)H analog is thio-NAD(P)H.

3. The method as claimed in claim 1, where the NAD(P)H analog is seleno-NAD(P)H.

4. The method as claimed in claim 1, where in step a) the sample is furthermore mixed with a fibrin aggregation inhibitor.

5. The method as claimed in claim 1, where the substance for activating factor XIII to factor XIIIa is thrombin.

6. The method as claimed in claim 1, where the acceptor substrate for factor XIIIa having at least one glutaminyl group is a polypeptide which has at least one glutamine radical as amine acceptor.

7. The method as claimed in claim 1, where the amino group donor substrate for factor XIIIa is a primary amine, preferably a primary amine from the group consisting of ethanolamine, putrescine, cadaverine, diaminoethane, aminoethane, glycine ethyl ester and glycine methyl ester.

8. The method as claimed in claim 1, where the agent capable of oxidizing, in the presence of ammonia, NAD(P)H to NAD(P)+ or an NAD(P)H analog to the corresponding NAD(P)+ analog comprises an enzyme and a substrate for the enzyme.

9. The method as claimed in claim 8, where the enzyme is glutamate dehydrogenase and the substrate for the enzyme is α-ketoglutarate.

10. The method as claimed in claim 1, where in step a) the sample is furthermore mixed with a heparin-neutralizing substance, preferably with hexadimethrine bromide, and/or with calcium chloride.

11. The method as claimed in claim 1, where the change in absorption of the test mixture is measured using light of a wavelength of about 340 nm to about 430 nm, preferably light of a wavelength of about 380 nm to about 420 nm, very particularly preferably light of a wavelength of about 390 to about 410 nm.

12. The use of an NAD(P)H analog having an absorption maximum above 350 nm in a method for determining factor XIII in a sample.

13. The use of the NAD(P)H analog thio-NAD(P)H in a method for determining factor XIII in a sample.

14. The use of the NAD(P)H analog seleno-NAD(P)H in a method for determining factor XIII in a sample.

15. A test kit for carrying out a method for determining factor XIII in a sample, where the test kit comprises the following components:
a. a first reagent comprising a substance or a substance mixture for activating factor XIII to factor XIIIa, preferably thrombin;
b. a second reagent comprising
at least one acceptor substrate having at least one glutaminyl group for factor XIIIa,
at least one amino group donor substrate for factor XIIIa, preferably a primary amine, and
at least one agent capable of oxidizing, in the presence of ammonia, NAD(P)H to NAD(P)+ or an NAD(P)H analog to the corresponding NAD(P)+ analog, the agent preferably consisting of glutamate dehydrogenase and α-ketoglutarate; and
c. a third reagent comprising at least one NAD(P)H analog having an absorption maximum above 350 nm.

16. The test kit as claimed in claim 15, where the third reagent comprises the NAD(P)H analog thio-NAD(P)H.

17. The test kit as claimed in claim 15, where the third reagent comprises the NAD(P)H analog seleno-NAD(P)H.

18. The test kit as claimed in claim 15, where the first reagent comprises thrombin for activating factor XIII to factor XIIIa and additionally calcium chloride and/or a fibrin aggregation inhibitor and/or hexadimethrine bromide.
